(19) United States
(12) Patent Application Publication
(10) Pub. No.: US 2007/0196167 A1
(43) Pub. Date: Aug. 23, 2007

(54) Dowel-house hi-performance flywheel coupler

(76) Inventor: Thomas Russ, Willoughby Hills, OH (US)

Correspondence Address: THOMAS RUSS, 2900 ERICH DRIVE, WILLOUGHBY HILLS, OH, 44092, US

(21) Appl. No.: 11/706,020

(22) Filed: Feb. 14, 2007

Related U.S. Application Data
(60) Provisional application No. 60/766,941, filed on Feb. 21, 2006.

(51) Int. Cl. B25G 3/28

(52) U.S. Cl. 403/356

(57) ABSTRACT

A combination thrust-washer & pin configured unit that is inserted from the flywheel side of the joining crankshaft and flywheel. Bolted together with a step cut gland nut, the dowel pins are held at a right angle to the crankshaft torque direction thus eliminating deflection forces created by leaning pins. The dowels are held in proper right-angle shear configuration producing a strength gain over the standard dowels that are in the crankshaft only. Hole elongation of the crank is greatly reduced in hi-powered engine application that use dowel pin coupling. The thick thrust washer provides a press fit retainer for the pins and as a secondary benefit provides a superior clamping over the previous passive flatwasher methods where the pins are in the crank only.

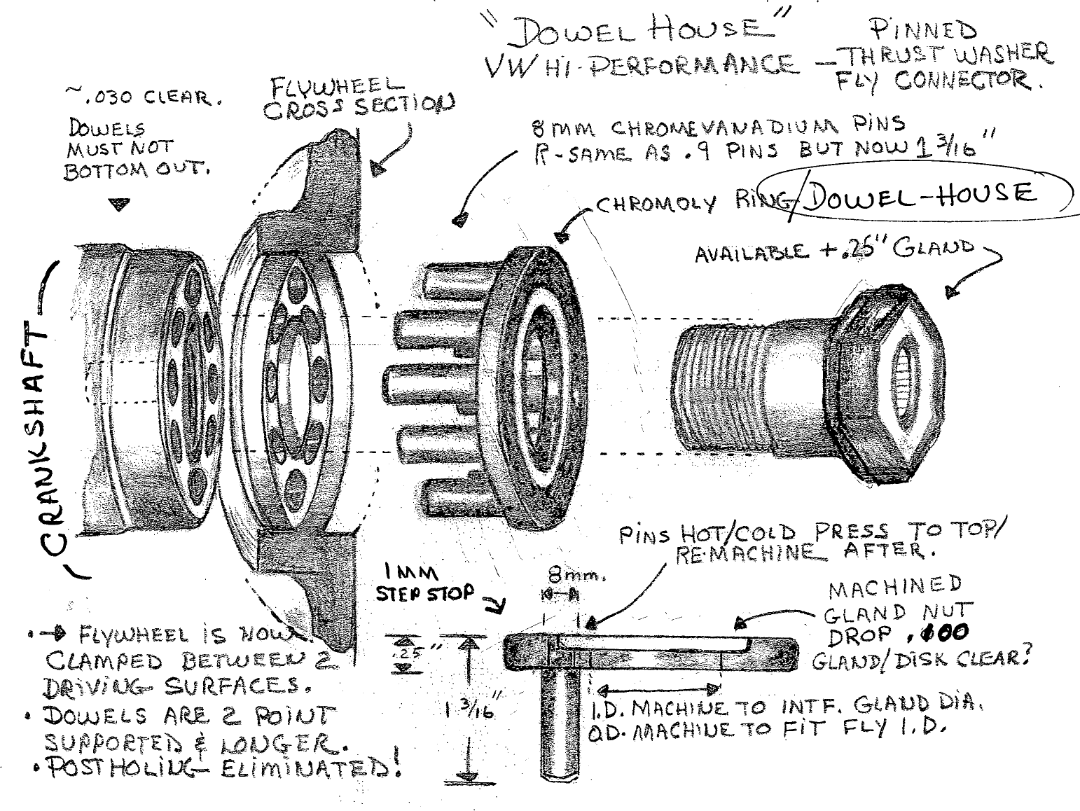

### CROSS REFERENCING

I claim priority to Provisional patent application No. 60/766,941 as filed on 02-21-06

### GENERAL

Performance device for flywheel-to-crankshaft coupling for use in aftermarket engine building.

### TYPICAL USE

In the field of VW air-cooled engine building for use in sport , street , racing etc.

Developed horsepower on said engines has evolved to the point where it has exceded the load bearing capability of the current state of the art coupling design in 8 dowel format. Based on a 30 year old standard 8 dowel method, this technology has remained in use today because a cure for the weakness was cost prohibiting. This low cost modification would bridge the gap and provide added strength to this continually less effective older coupling method.

Submitted drawing (Page Four) with exploded view and cross section of flywheel as it would be assembled using the dowel-pin ring/thrustwasher combination or as it is referenced to in this document as Dowel-House.

Bottom right view of Dowel-house cross section to show recess cuts to recapture the clearances and position of a stock gland-nut.

### MATERIAL SPECIFICATIONS

### Ring:

### Chrome-moly steel ring 4140 or similar 30 r hardness.

### Pins: e6150 Chrome Vanadium core 45r surface 59r.

### Gland Nut: Chrome-moly machined to step cut.

### (Not necessarily part of the Dowel-House concept as this nut is readily available in its unmodified form).

Nut must be modified to work with the Dowel-House to recapture the needed clearances lost with the extra-thick thrust ring in the Dowel-House.

### What there was Prior to the Dowel-House :

The large aftermarket engine and hi-performance engine builders have relied upon an industry adopted standard of dowels pressed into the crankshaft only. The protruding nubs of the dowels then projected into the much too thin flange of the flywheel. Pins could not extend fully into the flywheel flange due to the clearance required after torquing of the gland-nut as to not hit the standard flat washer. Hitting the washer would breech any actual clamping of the flywheel. This further weakened the shear-contact area in the flywheel. Single sided support of the dowels (only in the crank) have a tendency to “posthole” or elongate over time with a progressive destruction rate. This lay-over of the pins then produces a non-ideal geometry for the pins taking them from right angle shear into a deflection capable situation.

The Dowel-House coupler is in specific design to strengthen the 8 dowel configured cranks and flywheels.

There exists totally redesigned flange cranks and weld method coupling in this industry but nothing to address the 8 dowel weakness in its standard format. The 8 dowel format is by far the most widely used and affordable format spanning a 30 year period of performance use. This would close the bad gaps in its performance future.

What is claimed is:

1. The strengthening of the coupling between the crankshaft and the flywheel where exists an 8 dowel shear interface. Said device consists of an oversized thrust-washer to be press fitted with 8 dowel pins of 30 mm length to project into the crankshaft fitment just short of bottoming. The ring is drilled to exact SPG standard hole offset pattern to match the flywheel and crank alike. The said technology replaces the “pins-in-crank” that allowed for only one point support. Two point pin support secures the movement of all 8 dowels and maintains the 90 degree optimum shear geometry and zero pin deflection geometry. Crankshaft postholing is greatly reduced in this manor. The unit consists of a machined steel ring that is step cut for the gland-nut in this way to emulate stock clearancing of the clutch disk. Said ring holds selected size or 8 mm dowel pins via a press and shrink fit method of insertion. Dowels are individually step ground to their respective stop points in the ring. Said coupler provides reverse installed pins projecting first through the flywheel 100% (previously not attainable) and then into the crankshaft. Assembly to be finally bolted together with a standard gland-nut modified for disk clearance by way of a washer step cut of 0.100 inch to compensate for the Dowel-House washer thickness. Said device designed to be torqued to 400 plus foot-pound capability providing superior coupling and attaining higher power limitations in the 8 dowel format.
